(19) United States
(12) Patent Application Publication
(10) Pub. No.: US 2024/0210792 A1
(43) Pub. Date: Jun. 27, 2024

(54) CAMERA ACTUATOR

(71) Applicant: SAMSUNG ELECTRO-MECHANICS CO., LTD., Suwon-si (KR)

(72) Inventors: Ju Ho KIM, Suwon-si (KR); Donghoon LEE, Suwon-si (KR); Sanghyun JI, Suwon-si (KR); Dooseub SHIN, Suwon-si (KR); Dohwan KIM, Suwon-si (KR)

(73) Assignee: SAMSUNG ELECTRO-MECHANICS CO., LTD., Suwon-si (KR)

(21) Appl. No.: 18/359,332

(22) Filed: Jul. 26, 2023

(30) Foreign Application Priority Data
Dec. 22, 2022 (KR) 10-2022-0182219

(51) Int. Cl. G03B 13/36; G02B 7/02

(52) U.S. Cl. CPC G03B 13/36; G02B 7/021

(57) ABSTRACT

A camera actuator includes a lens module including a plurality of lenses, a carrier accommodating the lens module, a guiding unit disposed between the lens module and the carrier, a housing accommodating the carrier, a first actuator disposed between the lens module and the guiding unit, including a first portion attached to the guiding unit, and moving the lens module along a first direction perpendicular to an optical axis of the plurality of lenses, and a second actuator disposed between the guiding unit and the carrier, including a second portion attached to the guiding unit, and moving the lens module along a second direction perpendicular to the optical axis.

### CROSS-REFERENCE TO RELATED APPLICATIONS

This application claims the benefit under 35 USC 119(a) of Korean Patent Application No. 10-2022-0182219 filed in the Korean Intellectual Property Office on Dec. 22, 2022, the entire disclosure of which is incorporated herein by reference for all purposes.

### BACKGROUND

### 1. Field

The present disclosure relates to a camera actuator.

### 2. Description of the Background

Cameras may be adopted in portable electronic devices such as smartphones, tablet PCs, or laptop computers, and an autofocus (AF) function, an image stabilizer (IS) function, and a zoom function may be added to the portable electronic devices.

An electronic device on which a camera module is mounted may be thinner than previously manufactured electronic devices, the size of a camera module may also be smaller, and as a result, the influence of the hand shake of the user may increase. Therefore, reduction of the effects of a user's hand shake may improve image stabilization.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera actuator includes a lens module including a plurality of lenses, a carrier accommodating the lens module, a guiding unit disposed between the lens module and the carrier, a housing accommodating the carrier, a first actuator disposed between the lens module and the guiding unit, including a first portion attached to the guiding unit, and moving the lens module along a first direction perpendicular to an optical axis of the plurality of lenses, and a second actuator disposed between the guiding unit and the carrier, including a second portion attached to the guiding unit, and moving the lens module along a second direction perpendicular to the optical axis.

The first actuator may include a first piezoelectric member, and the second actuator may include a second piezoelectric member.

The first portion may be the first piezoelectric member, and the second portion may be the second piezoelectric member.

The first piezoelectric member may be attached to the upper surface of the guiding unit facing the bottom surface of the lens barrel, and the second piezoelectric member may be attached to the bottom surface of the guiding unit facing the carrier.

The camera actuator may further include a first rolling member disposed between the lens module and the guiding unit, and a second rolling member disposed between the guiding unit and the carrier.

The lens module may include a lens barrel including the plurality of lenses and a lens holder accommodating the lens barrel. The bottom surface of the lens holder may have a first guide groove, the upper surface of the guiding unit may have a second guide groove, the bottom surface of the guiding unit may have a third guide groove, and the upper surface of the carrier may have a fourth guide groove.

The first rolling member may move along the first guide groove and the second guide groove, and the second rolling member may move along the third guide groove and the fourth guide groove.

The first guide groove and the second guide groove may be parallel to the first direction, and the third guide groove and the fourth guide groove may be parallel to the second direction.

The camera actuator may further include a stopper coupled with the carrier, and an upper guiding unit and an elasticity unit disposed between the stopper and the lens module.

A portion of the upper surface of the lens module may have a groove, and the upper guiding unit and the elasticity unit may be disposed on the groove.

The first actuator may further include a first friction pad, and the second actuator may further include a second friction pad.

The first portion may be one of the first piezoelectric member and the first friction pad, and the second portion may be one of the second piezoelectric member and the second friction pad.

The first portion may be attached to the upper surface of the guiding unit, and the second portion may be attached to the bottom surface of the guiding unit facing the carrier.

The other of the first piezoelectric member and the first friction pad may be attached to the bottom surface of the lens module, and the other of the second piezoelectric member and the second friction pad may be attached to the upper surface of the carrier.

The camera actuator may further include first and second rolling members disposed between the lens module and the carrier.

The bottom surface of the lens module may have a first guide groove, the upper surface of the guiding unit may have a second guide groove, the bottom surface of the guiding unit may have a third guide groove, the upper surface of the carrier may have a fourth guide groove, the first rolling member may move along the first guide groove and the second guide groove, and the second rolling member may move along the third guide groove and the fourth guide groove.

In another general aspect, a camera actuator includes a carrier configured to move in an optical axis direction to focus a plurality of lenses disposed on the optical axis, a guiding unit disposed on the carrier and configured to be movable in a first direction perpendicular to the optical axis, a lens module comprising the plurality of lenses, disposed on the guiding unit, and configured to be movable in a second direction perpendicular to the optical axis, and an actuator disposed between the guiding unit and the carrier, the actuator including a piezoelectric member configured to move the guiding unit in the first direction.

The actuator may further include the piezoelectric member disposed on one of a bottom surface of the guiding unit and an upper surface of the carrier, and a friction pad disposed on the other of the bottom surface of the guiding unit and the upper surface of the carrier.

The camera actuator may further include a rolling member disposed between the guiding unit and the carrier.

Other features and aspects will be apparent from the following detailed description, the drawings, and the claims.

### BRIEF DESCRIPTION OF THE DRAWINGS

FIG. 1 is a schematic cross-sectional view of a camera module (camera actuator) according to an embodiment.

FIG. 2 is a perspective view of a camera actuator of FIG. 1.

FIG. 3 to FIG. 6 are perspective views showing a portion of a camera actuator of FIG. 1 and FIG. 2.

FIG. 7 is a cross-sectional view of a camera module (camera actuator) according to another embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Further, throughout the specification, an expression “on a plane” may indicate a case where a target is viewed from the top, and an expression “on a cross section” may indicate a case where a cross section of a target taken along a vertical direction is viewed from its side.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

A technology to prevent the hand shake by using a magnet and a coil has been developed, but as the performance of the camera improves, a magnetic field interference between the hand shake prevention unit and other drivers may occur, and the consumption voltage may increase when driving the camera module.

Embodiments are intended to provide a camera actuator capable of preventing the magnetic field interference from occurring between the hand shake prevention unit and other drivers and preventing the increasing in the driving voltage.

However, the object to be achieved by the embodiments is not limited to the above-mentioned objects, but may be variously expanded without departing from the technical spirit of this disclosure.

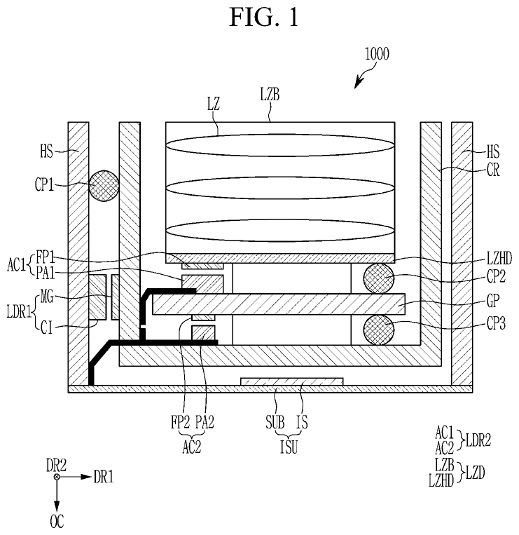

A camera module (camera actuator) 1000 according to an embodiment is described with reference to FIG. 1. FIG. 1 is a schematic cross-sectional view of a camera module according to an embodiment.

Referring to FIG. 1, the camera module 1000 according to one embodiment may include a housing HS, a lens module LZD including a lens barrel LZB and a lens holder LZHD, a carrier CR, a guiding unit GP, a first lens driver LDR1, a second lens driver LDR2, and an image sensor unit ISU.

The lens barrel LZB may include a plurality of lenses LZ disposed along the optical axis direction OC, and the guiding unit GP and the lens holder LZHD may be housed in the carrier CR together with the lens barrel LZB. The guiding unit GP and the lens holder LZHD may play a role of guiding the movement of the lens barrel LZB.

The housing HS may accommodate the carrier CR, the first lens driver LDR1, and the second lens driver LDR2.

The housing HS may have a polyhedral shape with a cross-section of a quadrangle and a predetermined height. However, the shape of the housing HS is not limited to a polyhedral shape with a quadrangle cross-section.

The lens barrel LZB may move along the optical axis direction OC while being accommodated in the housing HS by the driving force of the first lens driver LDR1. As the lens barrel LZB moves in the optical axis direction OC, a plurality of lenses LZ of the lens barrel LZB may be focused.

The lens barrel LZB may be moved along the first direction DR1 or the second direction DR2, which is perpendicular with the optical axis direction OC, by the driving force of the second lens driver LDR2. As the lens barrel LZB moves along the first direction DR1 or the second direction DR2, errors caused by the motion of the camera module may be corrected.

The first lens driver LDR1 may include a magnet MG and a coil CI attached to the housing HS and the carrier CR. The magnet MG may be attached to any one of the housing HS or the carrier CR, and the coil CI may be attached to the other one of the housing HS or the carrier CR.

A first rolling member CP1 may be disposed between the housing HS and the carrier CR, and when the carrier CR to which the lens barrel LZB is housed is moved along the optical axis direction OC, the friction between the housing HS and the carrier CR may be reduced. The first rolling member CP1 may be in a form of a ball. A guide groove for guiding the first rolling member CP1 to be accommodated and moved along the optical axis direction OC may be formed in the carrier CR.

The second lens driver LDR2 may include a first actuator AC1 disposed between the lens holder LZHD and the guiding unit GP, and a second actuator AC2 disposed between the guiding unit GP and the carrier CR.

The first actuator AC1 disposed between the lens holder LZHD and the guiding unit GP may include a first piezoelectric member (PA1, a piezo member) and a first friction pad (FP1, a friction pad). The lens holder LZHD accommodating the lens barrel LZB may move along the first direction DR1 by the first actuator AC1, and the first piezoelectric member PA1 may have the shape extending in a direction parallel to the first direction DR1.

The second actuator AC2 disposed between the guiding unit GP and the carrier CR may include a second piezoelectric member PA2 and a second friction pad FP2. The lens holder LZHD may move along the second direction DR2 by the second actuator AC2, and the second piezoelectric member PA2 may have a form extending in a direction parallel to the second direction DR2.

According to the illustrated embodiment, the first piezoelectric member PA1 of the first actuator AC1 may be attached to the guiding unit GP, and the first friction pad FP1 of the first actuator AC1 may be attached to the lens holder LZHD, but is not limited thereto, the first piezoelectric member PA1 may be attached to any one of the lens holder LZHD and the guiding unit GP, and the first friction pad FP1 may be attached to the other one of the lens holder LZHD and the guiding unit GP.

According to the illustrated embodiment, the second piezoelectric member PA2 of the second actuator AC2 may be attached to the guiding unit GP, and the second friction pad FP2 of the second actuator AC2 may be attached to the carrier CR, but is not limited thereto, the second piezoelectric member PA2 may be attached to any one of the guiding unit GP and the carrier CR, and the second friction pad FP2 may be attached to the other one of the guiding unit GP or the carrier CR.

A second rolling member CP2 may be disposed between the lens holder LZHD and the guiding unit GP, and when the lens holder LZHD moves along the first direction DR1, the friction between the lens holder LZHD and the guiding unit GP may be reduced. The second rolling member CP2 may be in the form of a ball.

A third rolling member CP3 may be disposed between the guiding unit GP and the carrier CR, and when the lens holder LZHD moves along the second direction DR2, the friction between the guiding unit GP and the carrier CR may be reduced. The third rolling member CP3 may be in the form of a ball.

An image sensor unit ISU may be disposed under the housing HS. The image sensor unit ISU may convert light incident through the lens barrel LZB into an electric signal. The image sensor unit ISU may include an image sensor IS and a flexible printed circuit (FPC) SUB connected to the image sensor IS.

The image sensor IS may be a Charge Coupled Device (CCD) or Complementary Metal-Oxide Semiconductor (CMOS). The electric signal converted by the image sensor IS is output as an image through the display unit of a portable electronic device. The image sensor IS may be fixed to the flexible printed circuit (FPC) SUB and be electrically connected to the flexible printed circuit (FPC) SUB.

The lens holder LZHD, the carrier CR and the guiding unit GP may have overlapping holes with the image sensor IS. Through the holes of the lens holder LZHD, the carrier CR and the guiding unit GP, the light passing through the lens barrel LZB may be inflowed to the image sensor IS.

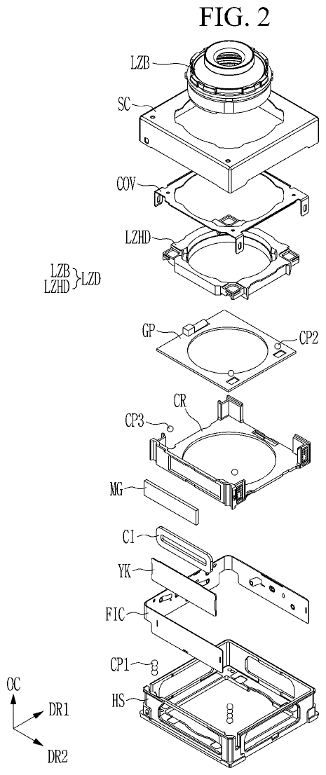

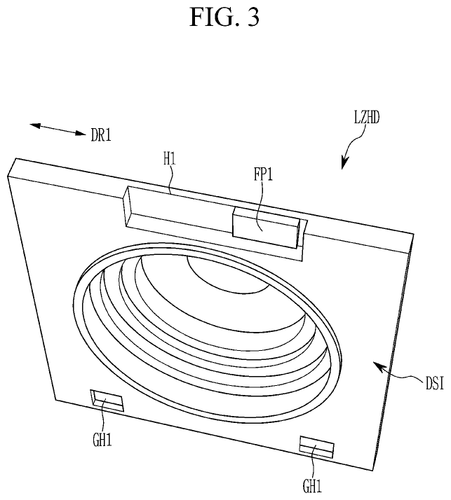

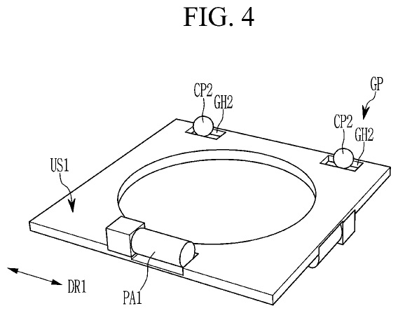

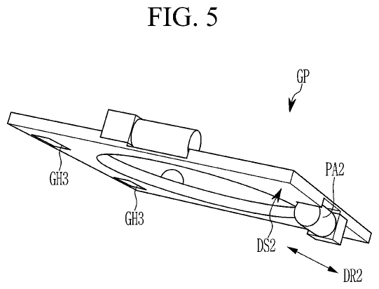

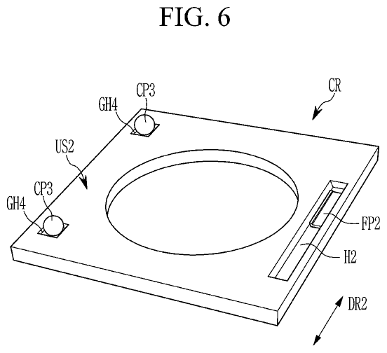

Next, the second driver of the camera module according to an embodiment is described with reference to FIG. 2 to FIG. 6. FIG. 2 is a perspective view of a camera actuator of FIG. 1, and FIG. 3 to FIG. 6 are perspective views showing a portion of a camera actuator of FIG. 1 and FIG. 2. FIG. 3 shows the bottom surface of the lens holder LZHD, FIG. 4 shows a portion of the upper surface of the guiding unit GP, FIG. 5 shows a portion of the bottom surface of the guiding unit GP, and FIG. 6 shows a portion of the upper surface of the carrier CR.

Referring to FIG. 2 along with FIG. 1, the lens module LZD may include the lens barrel LZB and the lens holder LZHD, and the lens barrel LZB is accommodated to the lens holder LZHD so that the lens module may be housed in the carrier CR together the guiding unit GP. The guiding unit GP and the lens holder LZHD may play a role of guiding the movement of lens barrel LZB.

The first lens driver LDR1 driving the lens barrel LZB along the optical axis direction OC may include the magnet MG mounted on the carrier CR and the coil CI and a yoke YK mounted on the housing HS.

A guide groove may be formed in the carrier CR so that the first rolling member CP1 may be accommodated and guided along the optical axis direction OC. When the lens barrel LZB moves along the optical axis direction OC by the first lens driver LDR1, the friction between the housing HS and the carrier CR may be reduced by the first rolling member CP1 accommodated in the guide groove formed on the carrier CR. A plurality of first rolling member CP1 may be disposed on both sides of the magnet MG, and the first rolling member CP1 may be in the form of a ball.

At the upper portion of the lens barrel LZB, a stopper COV may be further disposed to prevent the lens holder LZHD from escaping from the inner space of the carrier CR, and the stopper COV may be combined with the carrier CR.

The second lens driver LDR2 driving the lens barrel LZB may include a first actuator AC1 disposed between the lens holder LZHD and the guiding unit GP and a second actuator AC2 disposed between the guiding unit GP and the carrier CR by moving the lens barrel LZB along the first direction DR1 and/or the second direction DR2, which are perpendicular to the optical axis direction OC so as to correct errors caused by the motion of the camera module.

The housing HS may accommodate the carrier CR, and the first lens driver LDR1 and the second lens driver LDR2.

The housing HS may have a polyhedral shape with a cross-section of a quadrangle and a predetermined height. However, the shape of the housing HS is not limited to the polyhedral shape with the quadrangle cross-section.

The second rolling member CP2 may be disposed between the lens holder LZHD and the guiding unit GP, and when the lens holder LZHD moves along the first direction DR1, the friction between the lens holder LZHD and the guiding unit GP may be reduced. The second rolling member CP2 may be in the form of a ball. The second rolling member CP2 may play a role in maintaining the distance between the lens holder LZHD and the guiding unit GP.

Third rolling member CP3 may be disposed between the guiding unit GP and the carrier CR, and when the lens holder LZHD moves along the second direction DR2, the friction between the guiding unit GP and the carrier CR may be reduced. The third rolling member CP3 may be in the form of a ball. The third rolling member CP3 may play a role in maintaining the gap between the guiding unit GP and the carrier CR.

The Lens holder LZHD, the carrier CR and the guiding unit GP may have holes overlapping the image sensor IS.

A cover SC may be combined with the housing HS to cover the outer surface of the housing HS, and functions to protect internal components of the camera module. In addition, the cover SC may function to shield electromagnetic waves. For example, the cover SC may shield the electromagnetic waves so that the electromagnetic waves generated from the camera module do not affect other electronic parts in a portable electronic device.

In addition, since many electronic parts other than the camera module are mounted on the portable electronic device, the cover SC can shield the electromagnetic wave so that the electromagnetic wave generated from these electronic parts does not affect the camera module. The cover SC may be provided with a metallic material and be grounded on a ground pad provided in a flexible printed circuit (FPC), and thus may shield electromagnetic waves.

The circuit board FIC may be disposed between the cover SC and the housing HS, and the circuit board FIC may apply the driving voltage to the first lens driver LDR1 and the second lens driver LDR2.

Next, the lens holder LZHD, the guiding unit GP, and the carrier CR in which the first actuator AC1 and the second actuator AC2 are housed are described in detail with reference to FIG. 3 to FIG. 6 along with FIG. 1 and FIG. 2.

Referring to FIG. 3, a first friction pad FP1 among a first actuator AC1 of a second lens driver LDR2 is disposed on a bottom surface DS1 of a lens holder LZHD, and a plurality of first guide grooves GH1 are disposed on the bottom surface DS1 of the lens holder LZHD. A first groove H1 may be formed on the bottom surface DS1 of the lens holder LZHD, and the first friction pad FP1 may be disposed within the first groove H1.

Referring to FIG. 4, the first piezoelectric member PA1 among the first actuator AC1 of the second lens driver LDR2 is attached to the upper surface US1 of the guiding unit GP, and a plurality of second guide grooves GH2 are disposed on the upper surface US1 of the guiding unit GP. The first piezoelectric member PA1 of the first actuator AC1 may have a shape extending parallel to the first direction DR1. A plurality of first guide grooves GH1 and a plurality of second guide grooves GH2 may be disposed to face each other.

Among the first piezoelectric member PA1, the portion protruded from the upper surface US1 of the guiding unit GP may be disposed within the first groove H1 formed on the bottom surface DS1 of the lens holder LZHD. That is, the first groove H1 formed on the bottom surface DS1 of the lens holder LZHD may accommodate the first piezoelectric member PA1.

The first friction pad FP1 may be a magnetic material and have magnetism, and by the magnetism of the first friction pad FP1, the first piezoelectric member PA1 may be combined with the first friction pad FP1 and maintain the frictional force. However, the disclosure is not limited thereto, and the first friction pad FP1 may not be a magnetic material and have magnetism and the lens holder LZHD may include a separate magnet.

When a voltage is applied to the first piezoelectric member PA1 disposed on the upper surface US1 of the guiding unit GP, the first piezoelectric member PA1 may be deformed, and the deformation force of the first piezoelectric member PA1 is applied to the guiding unit GP to which the first piezoelectric member PA1 is attached, whereby the guiding unit GP and the lens holder LZHD may move along the first direction DR1 relative to each other.

A plurality of first guide grooves GH1 disposed on the bottom surface DS1 of the lens holder LZHD and a plurality of second guide grooves GH2 disposed on the upper surface US1 of the guiding unit GP may have a shape extending in a direction parallel to the first direction DR1.

A plurality of first guide grooves GH1 and a plurality of second guide grooves GH2 accommodate a plurality of second rolling members CP2 to guide the lens barrel LZB to easily move along the first direction DR1.

Referring to FIG. 5, the second piezoelectric member PA2 among the second actuator AC2 of the second lens driver LDR2 is attached to the bottom surface DS2 of the guiding unit GP, and a plurality of third guide grooves GH3 is disposed on the bottom surface DS2 of the guiding unit GP.

The second piezoelectric member PA2 of the second actuator AC2 may have a shape extending parallel to the second direction DR2.

Referring to FIG. 6, a second friction pad FP2 among the second actuator AC2 of the second lens driver LDR2 is disposed on the upper surface US2 of the carrier CR facing the bottom surface DS2 of the guiding unit GP, and a plurality of fourth guide grooves GH4 is disposed on the upper surface US2 of the carrier CR. A plurality of third guide grooves GH3 and a plurality of fourth guide grooves GH4 may be disposed to face each other.

A second groove H2 is formed on the upper surface US2 of the carrier CR, and the second friction pad FP2 may be disposed within the second groove H2.

Among the second piezoelectric member PA2 disposed on the bottom surface DS2 of the guiding unit GP, the portion protruded from the bottom surface DS2 of the guiding unit GP may be disposed within the second groove H2 formed on the upper surface US2 of carrier CR. That is, the second groove H2 formed on the upper surface US2 of the carrier CR may accommodate the second piezoelectric member PA2.

The second friction pad FP2 may be a magnetic material having magnetism, and by the magnetism of the second friction pad FP2, the second piezoelectric member PA2 may be combined with the second friction pad FP2 to maintain the frictional force. However, the disclosure is not limited thereto, and the second friction pad FP2 may not be a magnetic material having magnetism and the carrier CR may include a separate magnet.

When a voltage is applied to the second piezoelectric member PA2 disposed on the bottom surface of the guiding unit GP, the second piezoelectric member PA2 may be deformed, and the deformation force of the second piezoelectric member PA2 is applied to the guiding unit GP to which the second piezoelectric member PA2 is attached, as a result, the guiding unit GP and the carrier CR may move along the second direction DR2 relative to each other, and the lens barrel LZB may also move along the second direction DR2 relative to the carrier CR.

A plurality of third guide grooves GH3 disposed on the bottom surface of the guiding unit GP and a plurality of fourth guide grooves GH4 disposed on the upper surface of the carrier CR may have a shape extending in a direction parallel to the second direction DR2.

A plurality of third rolling members CP3 may be accommodated in a plurality of third guide grooves GH3 and a plurality of fourth guide grooves GH4 to guide the lens barrel LZB so as to be easily moved along the second direction DR2.

As described above, the first actuator AC1 and the second actuator AC2 may include the first piezoelectric member PA1 and the second piezoelectric member PA2, for example, may be one among an ultrasonic wave motor, an impact drive mechanism (IDM) motor, a smooth impact drive mechanism (SIDM) motor.

As described above, according to the camera module 1000 according to an embodiment, the second lens driver LDR2 for correcting the error caused by the motion of the camera module by moving the lens barrel LZB along the first direction DR1 and/or the second direction DR2 that are perpendicular to the optical axis direction OC may include the first actuator AC1 disposed between the lens holder LZHD and the guiding unit GP and the second actuator AC2 disposed between the guiding unit GP and the carrier CR, and the first actuator AC1 and the second actuator AC2 may be the piezoelectric actuator including the first piezoelectric member PA1 and the second piezoelectric member PA2.

Therefore, the first actuator AC1 and the second actuator AC2 may be driven with lower driving voltage than an actuator including a magnet and a coil, and an electromagnetic interference (EMI) with the first lens driver LDR1 may not occur because an electromagnetic force is not generated.

In addition, the interference between the first actuator AC1 and the second actuator AC2 may be reduced by positioning the first actuator AC1 and the second actuator AC2 above and below the guiding unit GP.

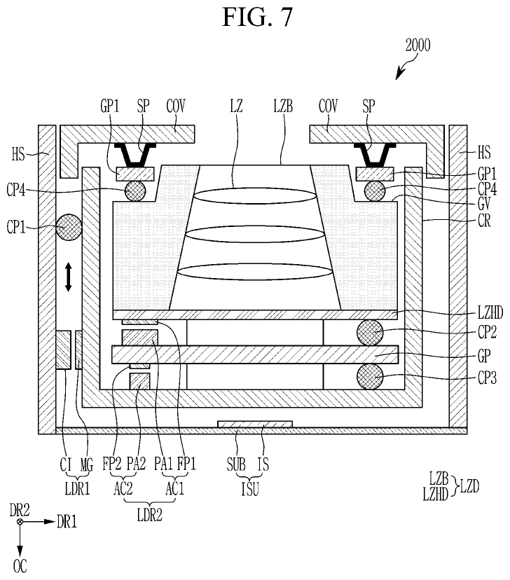

Next, a camera module (camera actuator) 2000 according to another embodiment is described with reference to FIG. 7. FIG. 7 is a cross-sectional view of a camera module according to another embodiment.

Referring to FIG. 7, the camera module 2000 according to the present embodiment is similar to the camera module 1000 according to the embodiment described with reference to FIG. 1 to FIG. 6. Thus, further detailed description of the same constituent elements is omitted.

Referring to FIG. 7, the camera module 2000 according to the present embodiment may include the housing HS, the lens barrel LZB, the lens holder LZHD, the carrier CR, the guiding unit GP, the first lens driver LDR1, the second lens driver LDR2, and the image sensor unit ISU.

The lens barrel LZB may move along the optical axis direction OC while being accommodated in the housing HS by the driving force of the first lens driver LDR1, and thereby a plurality of lenses LZ of the lens barrel LZB may be focused.

The lens barrel LZB may be moved along the first direction DR1 and/or the second direction DR2, which is perpendicular to the optical axis direction OC, by the driving force of the second lens driver LDR2. As the lens barrel LZB moves along the first direction DR1 or the second direction DR2, errors caused by the motion of the camera module may be corrected.

The first lens driver LDR1 may include the magnet MG and the coil CI attached to the housing HS and the carrier CR, the magnet MG may be attached to any one of the housing HS and the carrier CR, and the coil CI may be attached to the other of the housing HS and the carrier CR.

The first rolling member CP1 may be disposed between the housing HS and the carrier CR, and when the carrier CR including the lens barrel LZB moves along the optical axis direction OC, the friction between the housing HS and the carrier CR may be reduced. The first rolling member CP1 may be in the form of a ball. A guide groove for guiding the first rolling member CP1 to be accommodated and moved along the optical axis direction OC may be formed in the carrier CR.

The second lens driver LDR2 may include the first actuator AC1 disposed between the lens holder LZHD and the guiding unit GP, and the second actuator AC2 disposed between the guiding unit GP and the carrier CR.

The first actuator AC1 disposed between the lens holder LZHD and the guiding unit GP may include a first piezoelectric member PA1 and a first friction pad FP1, and a plurality of second rolling members CP2.

The second actuator AC2 disposed between the guiding unit GP and the carrier CR may include a second piezoelectric member PA2 and a second friction pad FP2, and a plurality of third rolling members CP3.

According to the illustrated embodiment, the first piezoelectric member PA1 of the first actuator AC1 may be attached to the guiding unit GP, and the first friction pad FP1 of the first actuator AC1 may be attached to the lens holder LZHD, but is not limited thereto, and the first piezoelectric member PA1 may be attached to one of the lens holder LZHD and the guiding unit GP, and the first friction pad FP1 may be attached to the other one of the lens holder LZHD and the guiding unit GP.

According to the illustrated embodiment, the second piezoelectric member PA2 of the second actuator AC2 may be attached to the guiding unit GP, and the second friction pad FP2 of the second actuator AC2 may be attached to the carrier CR, but is not limited thereto, and the second piezoelectric member PA2 may be attached to one of the guiding unit GP and the carrier CR, and the second friction pad FP2 may be attached to the other of the guiding unit GP and the carrier CR.

The image sensor unit ISU may be disposed below the housing HS, and the image sensor unit ISU may include an image sensor IS and a flexible printed circuit (FPC) SUB connected to the image sensor IS. The image sensor unit ISU may convert light incident through the lens barrel LZB into an electric signal.

The camera module 2000 according to the present embodiment, unlike the camera module 1000 according to the above-described embodiment, may include a stopper COV combined to the carrier CR, and an elasticity unit SP, an upper guiding unit GP1 and a plurality of fourth rolling members CP4 disposed via the lens barrel LZB.

A groove GV may be formed on the upper surface of the lens barrel LZB facing the stopper COV, and the upper guiding unit GP1 and a plurality of fourth rolling members CP4 may be disposed on the groove GV of the upper surface of the lens barrel LZB.

The elasticity unit SP may have an elasticity. For example, the elasticity unit SP may include a spring, but is not limited thereto.

The elasticity unit SP may be attached to the bottom surface of the stopper COV facing the upper surface of the lens barrel LZB, and may apply a compress force to the lens barrel LZB to be toward the guiding unit GP through the upper guiding unit GP1 and a plurality of fourth rolling members CP4. As a result, the contact force between the first piezoelectric member PA1 and the first friction pad FP1 of the first actuator AC1 disposed between the lens holder LZHD and the guiding unit GP may be increased, and the contact force between the second piezoelectric member PA2 and the second friction pad FP2 of the second actuator AC2 disposed between the guiding unit GP and the carrier CR may be increased.

A guide groove may be formed on the upper surface of the lens barrel LZB and the upper guiding unit GP1, and a plurality of fourth rolling members CP4 may be movable along the first direction DR1 and the second direction DR2. Accordingly, when the lens barrel LZB moves along the first direction DR1 and the second direction DR2 according to the driving of the first actuator AC1 and the second actuator AC2 of the second lens driver LDR2, the movement of the lens barrel LZB may be facilitated.

As described above, according to the camera module 2000 according to the embodiment, the second lens driver LDR2 for correcting the error caused by the motion of the camera module by moving the lens barrel LZB along the first direction DR1 and/or the second direction DR2 that is perpendicular to the optical axis direction OC may include the first actuator AC1 disposed between the lens holder LZHD and the guiding unit GP and the second actuator AC2 disposed between the guiding unit GP and the carrier CR, and the first actuator AC1 and the second actuator AC2 may be the piezoelectric actuator including the first piezoelectric member PA1 and the second piezoelectric member PA2.

Therefore, the first actuator AC1 and the second actuator AC2 may be driven with the lower driving voltage than the actuator including a magnet and a coil, and an electromagnetic interference (EMI) with the first lens driver LDR1 may not occur because an electromagnetic force is not generated.

All features of the camera module 1000 according to the embodiment described with reference to FIG. 1 to FIG. 6 above are all applicable to the camera module 2000 according to the present embodiment.

According to the embodiments, it is possible to provide the camera actuator capable of preventing the magnetic field interference from occurring between the hand shake prevention unit and other drivers and preventing the increasing in the driving voltage.

However, the effects of the embodiments are not limited to the above-described effects, and it is apparent that the embodiments can be variously expanded within a range that does not deviate from the spirit and scope of this disclosure.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera actuator comprising:
a lens module comprising a plurality of lenses;
a carrier accommodating the lens module;
a guiding unit disposed between the lens module and the carrier;
a housing accommodating the carrier;
a first actuator disposed between the lens module and the guiding unit, comprising a first portion attached to the guiding unit, and moving the lens module along a first direction perpendicular to an optical axis of the plurality of lenses; and
a second actuator disposed between the guiding unit and the carrier, comprising a second portion attached to the guiding unit, and moving the lens module along a second direction perpendicular to the optical axis.

2. The camera actuator of claim 1, wherein
the first actuator comprises a first piezoelectric member, and
the second actuator comprises a second piezoelectric member.

3. The camera actuator of claim 2, wherein
the first portion is the first piezoelectric member, and
the second portion is the second piezoelectric member.

4. The camera actuator of claim 3, wherein
the first piezoelectric member is attached to the upper surface of the guiding unit, and
the second piezoelectric member is attached to the bottom surface of the guiding unit.

5. The camera actuator of claim 4, further comprising:
a first rolling member disposed between the lens module and the guiding unit; and
a second rolling member disposed between the guiding unit and the carrier.

6. The camera actuator of claim 5, wherein
the lens module comprises a lens barrel comprising the plurality of lenses and a lens holder accommodating the lens barrel,
the bottom surface of the lens holder has a first guide groove,
the upper surface of the guiding unit has a second guide groove,
the bottom surface of the guiding unit has a third guide groove,
the upper surface of the carrier has a fourth guide groove,
the first rolling member moves along the first guide groove and the second guide groove, and
the second rolling member moves along the third guide groove and the fourth guide groove.

7. The camera actuator of claim 6, wherein
the first guide groove and the second guide groove are parallel to the first direction, and
the third guide groove and the fourth guide groove are parallel to the second direction.

8. The camera actuator of claim 2, wherein
the first actuator further comprises a first friction pad, and
the second actuator further comprises a second friction pad.

9. The camera actuator of claim 8, wherein
the first portion is one of the first piezoelectric member and the first friction pad, and
the second portion is one of the second piezoelectric member and the second friction pad.

10. The camera actuator of claim 9, wherein
the first portion is attached to the upper surface of the guiding unit, and
the second portion is attached to the bottom surface of the guiding unit facing the carrier.

11. The camera actuator of claim 10, wherein
the other of the first piezoelectric member and the first friction pad is attached to the bottom surface of the lens module, and
the other of the second piezoelectric member and the second friction pad is attached to the upper surface of the carrier.

12. The camera actuator of claim 9, further comprising
first and second rolling members disposed between the lens module and the carrier.

13. The camera actuator of claim 12, wherein
the bottom surface of the lens module has a first guide groove,
the upper surface of the guiding unit has a second guide groove,
the bottom surface of the guiding unit has a third guide groove,
the upper surface of the carrier has a fourth guide groove,
the first rolling member moves along the first guide groove and the second guide groove, and
the second rolling member moves along the third guide groove and the fourth guide groove.

14. The camera actuator of claim 13, wherein
the first guide groove and the second guide groove are parallel to the first direction, and
the third guide groove and the fourth guide groove are parallel to the second direction.

15. The camera actuator of claim 1, further comprising:
a stopper coupled with the carrier; and
an upper guiding unit and an elasticity unit disposed between the stopper and the lens module.

16. The camera actuator of claim 15, wherein
a portion of the upper surface of the lens module has a groove, and
the upper guiding unit and the elasticity unit are disposed on the groove.

17. A camera actuator comprising:
a carrier configured to move in an optical axis direction to focus a plurality of lenses disposed on the optical axis;
a guiding unit disposed on the carrier and configured to be movable in a first direction perpendicular to the optical axis;
a lens module comprising the plurality of lenses, disposed on the guiding unit, and configured to be movable in a second direction perpendicular to the optical axis; and
an actuator disposed between the guiding unit and the carrier, the actuator comprising a piezoelectric member configured to move the guiding unit in the first direction.

18. The camera actuator of claim 17, wherein the actuator further comprises the piezoelectric member disposed on one of a bottom surface of the guiding unit and an upper surface of the carrier, and a friction pad disposed on the other of the bottom surface of the guiding unit and the upper surface of the carrier.

19. The camera actuator of claim 17, further comprising a rolling member disposed between the guiding unit and the carrier.

20. The camera actuator of claim 17, further comprising:
a stopper coupled with the carrier; and
an upper guiding unit and an elasticity unit disposed between the stopper and the lens module.
